(19) United States
(12) Patent Application Publication
(10) Pub. No.: US 2004/0194091 A1
(43) Pub. Date: Sep. 30, 2004

(54) System and method for capturing and managing a process flow

(76) Inventors: Mason L. Weems, Austin, TX (US); John J. Watters, Austin, TX (US); L. Wayne Walker, Austin, TX (US); Keith L. Smethers, Austin, TX (US); Julie A. Holden, Austin, TX (US); Kathrin T. Brewer, Austin, TX (US)

Correspondence Address: Jeffrey C. Hood, Conley, Rose, & Tayon, P.C., P.O. Box 398, Austin, TX, 78767, US

(21) Appl. No.: 10/265,807

(22) Filed: Oct. 7, 2002

Related U.S. Application Data
(60) Provisional application No. 60/394,828, filed on Jul. 10, 2002.

(51) Int. Cl. G06F 9/00; G06F 9/46

(52) U.S. Cl. 718/100

(57) ABSTRACT

A monitoring software program for capturing data regarding the process flow may be installed. Information regarding a plurality of steps may be stored in a database. At least one output may be constructed in response to user input, wherein said constructing comprises retrieving information from said database. In one embodiment, constructing the output may further comprise processing said retrieved information from said database. In various embodiments, the output may comprise a flow file, a comparison of a historical flow file to a reference flow file, a report of history of a database object, verification of “up-to-date”-ness of a database object, verification of an outcome of a process that created an output, or a report of quality of an object (such as an input, an output, or a step) in said database.

### PRIORITY CLAIM

This application claims benefit of priority of U.S. provisional application Serial No. 60/394,828 titled “SYSTEM AND METHOD FOR CAPTURING AND MANAGIN A PROCESS FLOW” filed Jul. 10, 2002, whose inventors are Mason L. Weems, John J. Watters, L. Wayne Walker, Keith L. Smethers, Julie A. Holden and Kathrin T.Brewer.

### BACKGROUND OF THE INVENTION

1. Field of the Invention

The present invention relates to computer software, and more particularly to a system and method for capturing and managing a process flow.

2. Description of the Related Art

Complex processes or flows involving large amounts of data, many files, and many tools (e.g., in integrated circuit hardware development) often include dozens of steps, executed over many iterations, on a large collection of evolving data files. Even in the hands of a seasoned expert, repeating these series of steps or process flows is error prone.

As unexpected problems occur in day-to-day operations, and workarounds possibly involving new tools or scripts are inserted into an allegedly “golden” process flow, many times these workarounds are not captured and/or communicated to all interested parties, for use on the next iteration. Thus, the same problem may present itself on future iterations of a given process flow, and the problem may need to be solved again, causing duplication of effort and increased costs. These unexpected problems may be categorized as follows: data integrity, flow standardization, flow integrity, flow management, project tracking.

Data integrity refers to whether the correct version of each file is used or accessed in the process flow. If out-of-date versions and/or stray versions of any file are used, unpredictable results may occur. Data integrity may be checked by reference to records of some sort (e.g., manual, automated, stored in a database) as to the version of a given file. Many times in practice, either data integrity records are simply not kept, or checking them is deemed too cumbersome or time-consuming, and thus such checking is not done.

Flow standardization refers to capturing the expert knowledge that went into the development of the process flow in an understandable format. Flow standardization may include details regarding how to invoke various tools (e.g., environment variables needed, specific commands, command-line arguments). Flow integrity refers to whether all the steps in a given process flow are performed correctly, using the right tools at the right time, given that the correct data are used.

Flow management refers to maintaining a “golden” process flow over time. For example, if an error in a given tool arises, resolving that error may require a complicated workaround and/or the addition of a new tool or script that may replace and/or supplement the current version of the “golden” process flow. Typically, the task of capturing these changes to the “golden” process flow, thus creating a new and improved “golden” process flow for use on future iterations of the process, is left undone, due to the complexity of making changes to the “golden” process flow.

Project tracking refers to maintaining records of the status (e.g., success, failure) of various executions of a given process flow, as well as status of sub-steps (e.g., success, failure, whether a given sub-step was run or not on a given iteration) of the given process flow.

For the foregoing reasons, there is a need for an improved system and method for capturing and managing a process flow.

### SUMMARY OF THE INVENTION

The present invention provides various embodiments of a method and system for capturing and managing a process flow. A monitoring software program for capturing data regarding said process flow may be installed. The monitoring software program may be configured with configuration information regarding said process flow desired to be monitored, wherein said configuration information comprises information regarding said plurality of steps to be monitored in said process flow.

Information regarding said plurality of steps may be stored in a database, wherein a subset of said plurality of steps are performed on one or more computer systems in response to first user input, wherein each of said steps comprises one or more process steps.

Second user input requesting at least one output may be received. The at least one output may be constructed in response to said second user input, wherein said constructing comprises retrieving information from said database. In one embodiment, constructing the output may further comprise processing said retrieved information from said database.

In one embodiment, the output may comprise a flow file. The output may comprise a comparison of a historical flow file to a reference flow file, and constructing the output may further comprise creating a report listing differences between said historical flow file and said reference flow file. In one embodiment, the output may comprise a report of history of an object in said database, and constructing the output may further comprise creating said report of history of said object in said database. In one embodiment, the output may comprise verification of “up-to-date”-ness of an object in said database, and constructing the output may further comprise creating an indicator of said “up-to-date”-ness of said object (such as an input, an output, or a step) in said database. In one embodiment, the output may comprise verification of an outcome of a process that created an output, and constructing the output may further comprise creating an indicator of said outcome (e.g., success or failure) of said process that created said output.

In one embodiment, the output may comprise a report of quality of an object (such as an input, an output, or a step) in said database, and constructing the output may further comprise creating said report of quality of said object in said database. The quality may be based on a plurality of user-defined metrics. The plurality of user-defined metrics may comprise inherited user-defined metrics from an ancestor of said object in said database.

In one embodiment, error checking may be performed prior to, subsequent to, or in parallel with storing information regarding said plurality of steps in the database. Prior to allowing processing to continue, the errors may be fixed.

### BRIEF DESCRIPTION OF THE DRAWINGS

A better understanding of the present invention can be obtained when the following detailed description of various embodiments is considered in conjunction with the following drawings, in which:

FIG. 1 illustrates an exemplary server computer system according to one embodiment of the present invention;

FIG. 2 illustrates a network connecting the server computer system and a client computer system according to one embodiment of the present invention;

FIG. 3a is a diagram illustrating an overview of a generic process flow, according to one embodiment of the present invention;

FIG. 3b is a diagram illustrating an overview of a semiconductor design process flow, according to one embodiment of the present invention;

FIG. 4 is a diagram illustrating an overview of capturing and managing a process flow, according to one embodiment of the present invention; and

FIG. 5 is a flowchart illustrating an overview of capturing and managing a process flow, according to one embodiment of the present invention.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims.

### DETAILED DESCRIPTION OF SEVERAL EMBODIMENTS

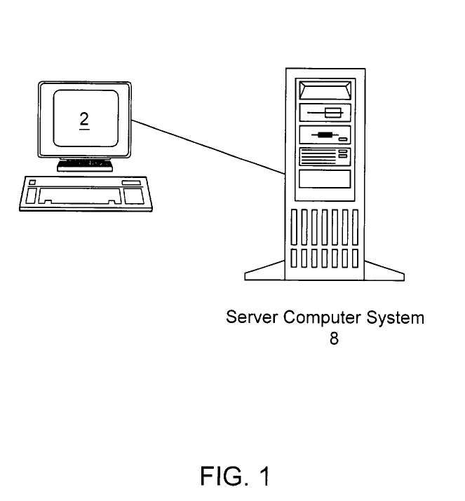

FIG. 1—Server Computer System

FIG. 1 illustrates a computer system 8 (e.g., a server computer system.8) operable to execute capturing and managing a process flow according to one embodiment. The server computer system 8 may be connected to any of various computer systems, networks or other systems to capture and/or manage a process flow.

Various embodiments of systems and methods for capturing and managing a process flow are described below. The server computer system 8 may be any type of computer system, including a personal computer system, mainframe computer system, workstation, personal digital assistant (PDA), television system or other device. In general, the term “computer system” may be broadly defined to encompass any device having at least one processor that executes instructions from a memory medium.

As shown in FIG. 1, the server computer system 8 may include a display device 2 operable to display operations associated with capturing and managing a process flow. The display device 2 may also be operable to display a graphical user interface for use in capturing and managing a process flow. The graphical user interface may comprise any type of graphical user interface, e.g., depending on the computing platform.

The server computer system 8 may include a memory medium(s) on which one or more computer programs or software components according to one embodiment of the present invention may be stored. For example, the memory medium may store one or more process flow capture and/or process flow management software programs which are executable to perform the methods described herein. Also, the memory medium may store a programming development environment application used to create and/or execute process flow capture and/or process flow management software programs. The memory medium may also store operating system software, as well as other software for operation of the computer system.

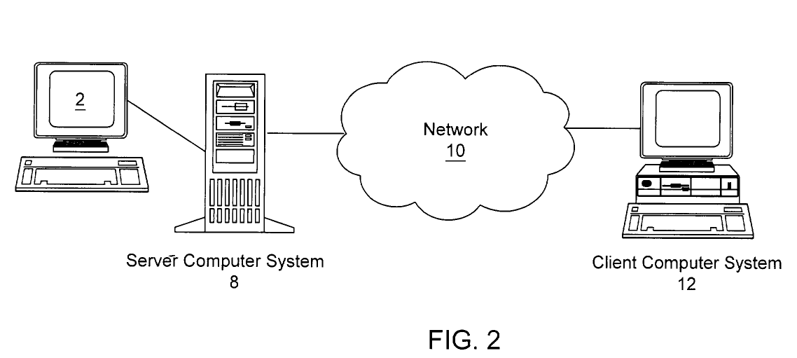

In one embodiment, the computer system 8 may be used to complement at least a portion of the process flow being captured. Thus the memory medium of the computer system 8 may also store one or more computer programs which receive user input specifying a process flow. In another embodiment, described in FIG. 2, the computer system 8 may be used to capture and or manage a process flow on one or more other computer systems.

The term “memory medium” is intended to include various types of memory or storage, including an installation medium, e.g., a CD-ROM, floppy disks, or tape device; a computer system memory or random access memory such as DRAM, SRAM, EDO RAM, Rambus RAM, etc.; or a non-volatile memory such as a magnetic media, e.g., a hard drive, or optical storage. The memory medium may comprise other types of memory or storage as well, or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer system for execution.

Various embodiments further include receiving or storing instructions and/or data implemented in accordance with the foregoing description upon a carrier medium. Suitable carrier media include memory media or storage media such as magnetic or optical media, e.g., disk or CD-ROM, as well as signals such as electrical, electromagnetic, or digital signals, conveyed via a communication medium such as networks and/or a wireless link.

FIG. 2—Exemplary System Embodiment

FIG. 2 illustrates a simplified and exemplary system that operates according to one embodiment of the present invention. As shown in the system of FIG. 2, the server computer system 8 is connected to one or more computer systems 12 through network 10. Thus, for example, the computer system 8 may be used to capture a process flow implemented on one or more second computer systems, wherein the second computer system may be local to or remote from the computer system 8. In addition, the computer system 8 may be used to capture a process flow performed at least partially on other types of devices, such as a device including an FPGA.

The network 10 may be any of various types of wide-area networks and/or local area networks, or networks of networks, such as the Internet, which connects computers and/or networks of computers together, thereby providing the connectivity for enabling various computer systems to communicate. Thus, the network 10 may be any of various types of networks, including wired networks, wireless networks, or any other type of network of computer systems.

It is noted that the computer system 12 in FIG. 2 is an exemplary embodiment. Thus, various different embodiments of computer system 12 may also be used, as desired. The computer system 12 shown in FIG. 2 may be implemented using one or more computer systems, e.g., in the simplest case, a single computer system, to a more complex case of a number of distributed computer systems, connected in various ways, as desired. Each of the computer systems 8 and 12 in FIG. 2 may include various standard components such as one or more processors or central processing units and one or more memory media, and other standard components, e.g., a display device, input devices, a power supply, etc. Each of the computer systems in FIG. 2 may also be implemented as two or more different computer systems. Also, the computer systems in FIG. 2 may take various forms, including a computer system, mainframe computer system, workstation, or other device.

Each of the computer systems in FIG. 2 preferably includes a memory medium on which computer programs are stored. The memory medium in the computer system 8 may store one or more software programs for implementing capturing and managing a process flow. The software programs may be implemented in any of various ways, A CPU of one of the computer systems 8 or 12 shown in FIG. 2 executing code and data from the memory medium comprises a means for implementing capturing and managing a process flow according to the methods or flowcharts described below.

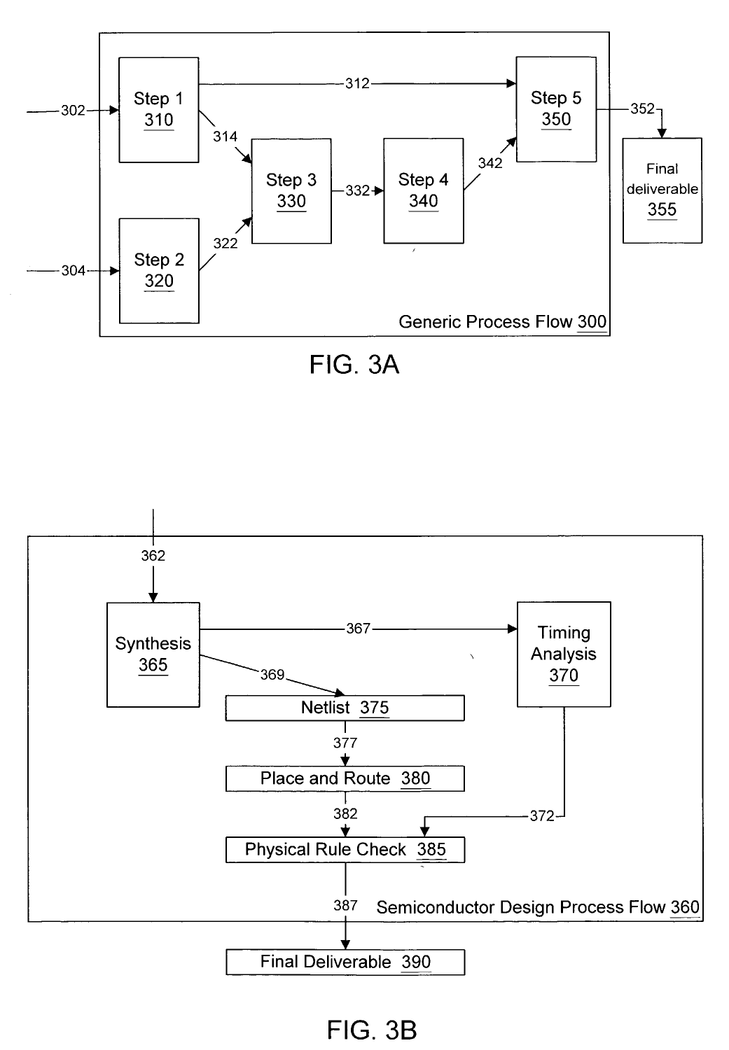

FIG. 3a —Diagram of a Generic Process Flow

FIG. 3a is one embodiment of a diagram illustrating an overview of a generic process flow.

As used herein, a “flow” is a set of interdependent processes or steps that are joined together by input files and output files (inputs and outputs), wherein the interdependent processes or steps may be run in parallel or in series, based on the dependency relationships of the inputs and outputs. The terms “flow” and “process flow” are used synonymously herein.

As used herein, a “step” is the leaf level of a process. A step is the execution or running of a tool or executable program. The term “program” includes software programs executable on a computer system, and hardware configuration programs that may be implemented on a p.h.e. such as an FPGA.

Generic process flow 300 may represent any type of process flow. Examples of process flows include, but are not limited to: the execution of processes in a manufacturing plant (e.g., a chemical manufacturing plant); a sequence of tasks (e.g., in manufacturing on a factory assembly floor, in semiconductor design, in software development); a series of check-off procedures (e.g., on a flight deck); a series of procedures (e.g., in a command & control center).

As shown in FIG. 3a, various inputs (i.e., arrow 302 and arrow 304) may be provided to one or more steps of the generic process flow 300. Although each input is shown as a single arrow, in various embodiments multiple inputs may be represented by the single arrows, and these multiple inputs may be received by various steps in the process. In the embodiment of FIG. 3a, arrows 302 and 304 are shown strictly as inputs to step 1 (labeled 310) and step 2 (labeled 320), respectively. Similarly, arrow 352 is shown strictly as an output from step 5 (labeled 350) leading to final deliverable 355. Although one particular embodiment is shown in FIG. 3a, the generic process flow 300 may include a variety of inputs, steps, and outputs which are interconnected in a variety of ways.

Arrows 312, 314, 322, 332, and 342 represent both outputs of one step and inputs to another step. Thus, arrow 312 represents the output from Step 1 (labeled 310) as well as the input to Step 5 (labeled 350); arrow 314 represents the output from Step 1 (labeled 310) as well as the input to Step 3 (labeled 330); arrow 322 represents the output from Step 2 (labeled 320) as well as the input to Step 3 (labeled 330); arrow 332 represents the output from Step 3 (labeled 330) as well as the input to Step 4 (labeled 340); arrow 342 represents the output from Step 4 (labeled 340) as well as the input to Step 5 (labeled 350).

The output from Step 1 (labeled 310) feeds two inputs (i.e., input to Step 3 (labeled 330) as shown by arrow 314 and input to Step 5 (labeled 350) as shown by arrow 312). For purposes of illustration, the two inputs are labeled as two different arrows (i.e., arrows 312 and 314). It is noted that there may be overlap between the information provided to Step 3 (labeled 330) and to Step 5 (labeled 350), from the output of Step 1 (labeled 310), depending on the needs of Steps 3 and 5. The output from the remaining steps (i.e., Steps 2 thru 5) are shown as feeding a single input each.

Step 3 (labeled 330) is shown as receiving two inputs (i.e., arrow 314 from the output of step 1 (labeled 310), and arrow 322 from the output of step 2 (labeled 320)). Similarly, Step 5 (labeled 350) is shown as receiving two inputs (i.e., arrow 312 from the output of step 1 (labeled 310), and arrow 342 from the output of step 4 (labeled 340)). Step 4 (labeled 340) is shown as receiving a single input (i.e., arrow 332 from the output of Step 3 (labeled 330)).

FIG. 3b —Diagram of a Semiconductor Design Process Flow

FIG. 3b is one embodiment of a diagram illustrating an overview of a semiconductor design process flow.

As shown in FIG. 3b, various inputs (i.e., arrow 372 and arrow 382) may be provided to one or more steps of the semiconductor design process flow 360. Although each input is shown as a single arrow, in various embodiments multiple inputs may be represented by the single arrows, and these multiple inputs may be received by various steps in the process. In the embodiment of FIG. 3b, arrow 362 is shown strictly as an input to synthesis step 365. Similarly, arrow 387 is shown strictly as an output from physical rule check step 385 leading to final deliverable 390. Although one particular embodiment is shown in FIG. 3b, the semiconductor design process flow 360 may include a variety of inputs, steps, and outputs which are interconnected in a variety of ways.

Arrows 367, 369, 372, 377, and 382 represent both outputs of one step and inputs to another step. Thus, arrow 367 represents the output from synthesis step 365 as well as the input to timing analysis step 370; arrow 369 represents the output from synthesis step 365 as well as the input to netlist step 375; arrow 372 represents the output from timing analysis step 370 as well as one of the two inputs to physical rule check step 385; arrow 377 represents the output from netlist step 375 as well as the input to place and route step 380; arrow 382 represents the output from place and route step 380 as well as one of the two inputs to physical rule check step 385.

The output from synthesis step 365 feeds two inputs (i.e., input to timing analysis step 370 as shown by arrow 367 and input to netlist step 375 as shown by arrow 369). For purposes of illustration, the two inputs are labeled as two different arrows (i.e., arrows 367 and 369). It is noted that there may be overlap between the information provided to timing analysis step 370 and to netlist step 375, from the output of synthesis step 365, depending on the needs of timing analysis step 370 and netlist step 375. The output from the remaining steps (i.e., timing analysis step 370, netlist step 375, place and route step 380, and physical rule check step 385) are shown as feeding a single input each.

Physical rule check step 385 is shown as receiving two inputs (i.e., arrow 372 from the output of timing analysis step 370, and arrow 382 from the output of place and route step 380). Each of the other steps in the semiconductor design process flow 360 are shown as receiving one input each from another step: timing analysis step 370 is shown as receiving a single input from the output of synthesis step 365 via arrow 367; netlist step 375 is shown as receiving a single input from the output of synthesis step 365 via arrow 369; place and route step 380 is shown as receiving a single input from the output of netlist step 375 via arrow 377.

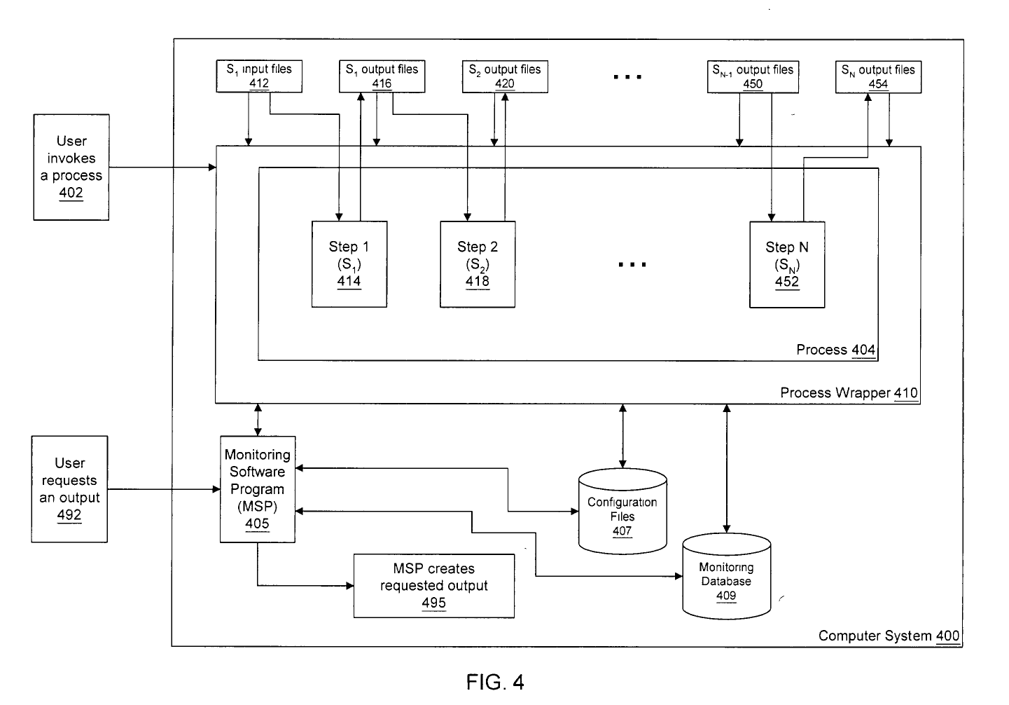

FIG. 4—Diagram of Capturing and Managing a Process Flow

FIG. 4 is one embodiment of a diagram illustrating an overview of capturing and managing a process flow.

A computer system 400 is shown in FIG. 4. The processing shown within computer system 400 may be distributed among two or more computer systems (e.g., a first computer system and a second different computer system connected to the first computer system over a network, such as the Internet), however, for purposes of illustration, the processing is shown entirely within one computer system (i.e., computer system 400).

Within computer system 400 is shown process wrapper 410. Within process wrapper 410 is shown process 404. Prior to a user invoking a process (e.g., process 404), as shown in step 402, the user may create parameter configuration and parameter rules (not shown) for a given process (e.g., process 404). These user-created parameter configuration and parameter rules may be stored in configuration files 407 and/or monitoring database 409.

One example of a parameter rule may be comparing a parameter's value to one or more user-provided values, and writing a message to a log based upon the results of the comparison (e.g., true, false). The severity of the message may be user-defined (e.g., fatal, error, warning). Data types for parameters may include, but are not limited to: integer, float, regular expression, enumeration, subroutine, program.

Although not shown, another action that may occur prior to the user invoking a process is the user establishing a process wrapper 410 around a given process (e.g., process 404). In one embodiment, the process wrapper 410 is assigned or linked such that when a user requests execution of a given process 404, the associated process wrapper 410 is actually executed instead. The process wrapper 410 “wraps” pre-processing and post-processing around the process 404 (or each step of the process). Examples of pre-processing actions and post-processing actions include, but are not limited to: verification and/or examination (e.g., of input files and output files), parameter checks, writing data to configuration files 407 and/or monitoring database 409.

Upon invocation of a process (i.e., step 402) that was previously associated with a process wrapper, the process wrapper 410 may perform pre-processing actions (e.g., verification of the existence of step 1 input files 412; running enforcement checks of various relevant parameter rules, as found in the configuration files or the monitoring database; interaction with the monitoring software program) prior to executing the process 404. These pre-processing actions (as well as the post-processing actions) may involve interaction with one or more of the monitoring software program 405, the configuration files 407, and the monitoring database 409. It is noted that pre-processing actions that result in some type of failure (e.g., a parameter value check against a parameter rule requirement resulting in failure) may result in the process being stopped.

After pre-processing is successfully completed, the process 404 steps may then be executed (e.g., step 1 (labeled 414), step 2 (labeled 418), up through step N (labeled 452)). It is noted that although the steps of process 404 are shown sequentially in FIG. 4, this is simply for purposes of illustration, thus the execution of the steps of process 404 may be run in parallel and/or in some other more complicated fashion than shown in FIG. 4. Similarly, the user interaction is shown only as beginning the processing (e.g., the arrow connecting step 402 with process wrapper 410), for purposes of illustration. It is noted that the user may initiate or invoke various steps for process 404 interactively or in some other manner than simply requesting execution of step 1 (labeled 414) of process 404.

Each step of process 404 is shown as having input files and output files, as follows: step 1 input files (labeled 412) are inputs to both step 1 (labeled 414) and to process wrapper 410; step 1 output files (labeled 416) are generated by the processing of step 1 (labeled 414); step 1 output files (labeled 416) are inputs to both step 2 (labeled 418) and to process wrapper 410; step 2 output files (labeled 420) are generated by the processing of step 2 (labeled 418); step 2 output files (labeled 420) are inputs to both step 3 (not shown) and to process wrapper 410; step N-1 output files (labeled 450) are generated by the processing of step N-1 (not shown); step N-1 output files (labeled 450) are inputs to both step N (labeled 452) and to process wrapper 410; step N output files (labeled 454) are generated by the processing of step N (labeled 452); step N output files (labeled 454) are inputs to process wrapper 410. It is noted that the step N output files (labeled 454), in addition to being the output of a step, are also the output of the process 404, as step N is the last step of processing for process 404.

The process wrapper 410 may perform post-processing actions either at the successful completion of the last step of processing for process 404, or at any intermediate step of processing for process 404 that results in an abnormal exit or failure from process 404.

Typically, after a process (e.g., process 404) is successfully completed, but possibly at some earlier point in time, the user may request an output, as shown in step 492. An output may be a report or a flow file or some other user-defined entity. The user request for an output is received by the monitoring software program 405. The monitoring software program 405 processes the request, with possible references to one or more of: the process wrapper 410, the configuration files 407, and the monitoring database 409. The monitoring software program 405 creates the requested output in step 495.

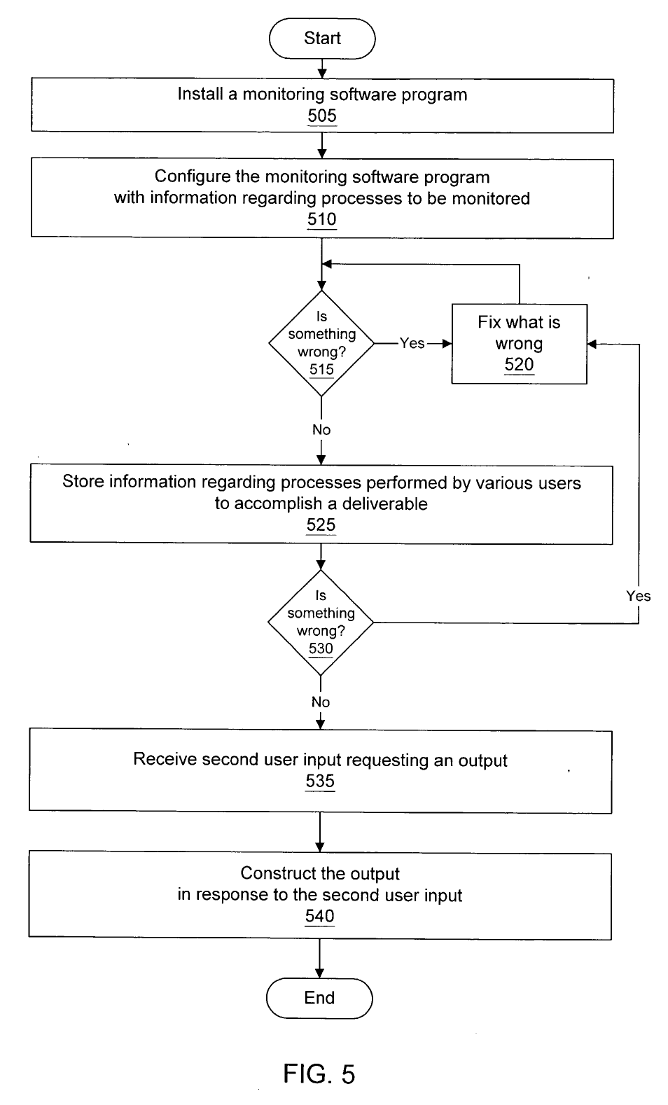

FIG. 5—Flowchart of Capturing and Managing a Process Flow

FIG. 5 is one embodiment of a flowchart illustrating an overview of capturing and managing a process flow. As used herein, a process flow comprises a plurality of steps.

As shown in step 505, a monitoring software program may be installed. The monitoring software program may be operable to capture data regarding the process flow. The monitoring software program may keep track of keystrokes or steps that are executed by a user, as well as the inputs and outputs generated by executed steps. As discussed below, the captured data may be stored (e.g., in a database) and retrieved in various ways (e.g., retrieval exactly as entered, retrieval in a user-defined manner).

In step 510, the monitoring software program may be configured with configuration information regarding the process flow desired to be monitored. The configuration information may include information regarding the plurality of steps to be monitored in the process flow. In one embodiment, one or more configuration files may be created. The configuration files may include settings for parameters or variables (e.g., environment variables) related to the process flow desired to be monitored. The configuration files may also include parameter rules.

Step 515 is a decision step. As various users invoke the plurality of steps to be monitored in the process flow, the monitoring software program may monitor or check the execution for errors of some kind (e.g., checks against the configuration information and/or information previously stored in a monitoring database). In the case where an error of some kind is found, processing may pass to step 520 to fix the error. Alternatively, in the case where no errors are found, processing continues with step 525. Although not shown, if in the processing of step 520 the error is determined to be unfixable, processing may terminate.

In step 525, information regarding the plurality of steps, as performed by various users to accomplish a deliverable, may be stored in a database. Examples of these steps may vary depending upon the problem domain. In semiconductor design, examples of various steps that may be performed include: performing a syntax check of a source file, checking the functional correctness of a behavioral description, translating a behavioral description into a gate-level netlist, performing placement and routing of a gate-level netlist to create a layout database, and checking a layout database for foundry process violations. In computer animation, examples of various steps that may be performed include: creating a wire-frame model, adding movement to a wire-frame model, adding a “skin” to a wire-frame model, adding sound to the animation, and adding an animated character into a scene. Other steps may include, for example, raising capital or certifying the financial results of a public company. As a user creates steps leading ultimately to a completed process, various database records may be created in parallel. Examples of types of database records created may include, but are not limited to: history, tool argument, wrapper argument, tool environment, wrapper environment, file (e.g., for inputs, steps, and outputs).

Step 530 is a decision step, similar to step 515. As various users invoke the plurality of steps to be monitored in the process flow, and information is stored in the database, the monitoring software program may monitor or check the execution for errors of some kind (e.g., checks against the configuration information and/or information previously stored in a monitoring database). In the case where an error of some kind is found, processing may pass to step 520 to fix the error. Alternatively, in the case where no errors are found, processing continues with step 535. Although not shown, if in the processing of step 520 the error is determined to be unfixable, processing may terminate.

As used herein, an output may be any user-requested output (e.g., a flow file, a report, an indicator). Examples of steps performed by various users include, but are not limited to: command-line entries, manual steps or tasks (e.g., editing a file, approving a document, approving an action).

In one embodiment, manual steps or tasks may be stored in the database by the user entering information related to the manual steps or tasks into the database. Command-line entries and/or other user input using any type of input device on a computer system may be automatically captured and stored in the database, by the monitoring software program. In one embodiment, each of the processes may include one or more steps.

In step 535, second user input may be received. The second user input may request at least one output. Examples of outputs that may be requested by a user include, but are not limited to: a flow file, a comparison of a historical flow file to a reference flow file, a report of history of an object in the database, verification of “up-to-date”-ness of an object in the database, verification of an outcome of a step that created an output, a report of quality of an object in the database.

In step 540, the at least one output may be constructed in response to the second user input. The constructing may include retrieving information from the database. After retrieval, the information may be processed. Examples of constructing various outputs include, but are not limited to: creating a report listing differences between the historical flow file and the reference flow file; creating the report of history of the object (e.g., an input, an output, or a step) in the database; creating an indicator of the “up-to-date”-ness of the object (e.g., an input, an output, or a step) in the database; creating an indicator of the outcome (e.g., success or failure) of the process that created the output; creating the report of quality (e.g., quality based on a plurality of user-defined metrics) of the object (e.g., an input, an output, or a step) in the database. The plurality of user-defined metrics may include inherited user-defined metrics from an ancestor of the object in the database.

Although the system and method of the present invention have been described in connection with several embodiments, the invention is not intended to be limited to the specific forms set forth herein, but on the contrary, it is intended to cover such alternatives, modifications, and equivalents as can be reasonably included within the spirit and scope of the invention as defined by the appended claims.

What is claimed is:

1. A method for capturing and managing a process flow, wherein said process flow comprises a plurality of steps, said method comprising:
installing a monitoring software program for capturing data regarding said process flow;
configuring said monitoring software program with configuration information regarding said process flow desired to be monitored, wherein said configuration information comprises information regarding said plurality of steps to be monitored in said process flow;
storing information regarding said plurality of steps in a database, wherein a subset of said plurality of steps are performed on one or more computer systems in response to first user input, wherein each of said steps comprises one or more process steps;
receiving second user input requesting at least one output;
constructing said at least one output in response to said second user input, wherein said constructing comprises retrieving information from said database.

2. The method of claim 1, wherein said constructing further comprises processing said retrieved information from said database.

3. The method of claim 1,
wherein said at least one output comprises a flow file.

4. The method of claim 1,
wherein said at least one output comprises a comparison of a historical flow file to a reference flow file;
wherein said constructing further comprises creating a report listing differences between said historical flow file and said reference flow file.

5. The method of claim 1,
wherein said at least one output comprises a report of history of an object in said database;
wherein said constructing further comprises creating said report of history of said object in said database.

6. The method of claim 1,
wherein said at least one output comprises verification of “up-to-date”-ness of an object in said database;
wherein said constructing further comprises creating an indicator of said “up-to-date”-ness of said object in said database.

7. The method of claim 6, wherein said object in said database comprises an input.

8. The method of claim 6, wherein said object in said database comprises an output.

9. The method of claim 6, wherein said object in said database comprises a step.

10. The method of claim 1,
wherein said at least one output comprises verification of an outcome of a process that created an output;
wherein said constructing further comprises creating an indicator of said outcome of said process that created said output.

11. The method of claim 10, wherein said outcome comprises success.

12. The method of claim 10, wherein said outcome comprises failure.

13. The method of claim 1,
wherein said at least one output comprises a report of quality of an object in said database;
wherein said constructing further comprises creating said report of quality of said object in said database.

14. The method of claim 13, wherein said quality is based on a plurality of user-defined metrics.

15. The method of claim 14, wherein said plurality of user-defined metrics comprise inherited user-defined metrics from an ancestor of said object in said database.

16. The method of claim 13, wherein said object in said database comprises an input.

17. The method of claim 13, wherein said object in said database comprises an output.

18. The method of claim 13, wherein said object in said database comprises a step.

19. The method of claim 1, further comprising error checking prior to said storing information regarding said plurality of steps in the database.

20. The method of claim 19, further comprising fixing any errors found prior to allowing processing to continue.

21. The method of claim 1, further comprising error checking subsequent to said storing information regarding said plurality of steps in the database.

22. The method of claim 21, further comprising fixing any errors found prior to allowing processing to continue.

23. The method of claim 1, further comprising error checking in parallel with said storing information regarding said plurality of steps in the database.

24. The method of claim 23, further comprising fixing any errors found prior to allowing processing to continue.

25. A carrier medium comprising program instructions for capturing and managing a process flow, wherein said process flow comprises a plurality of steps, wherein the program instructions are computer-executable to implement:
installing a monitoring software program for capturing data regarding said process flow;
configuring said monitoring software program with configuration information regarding said process flow desired to be monitored, wherein said configuration information comprises information regarding said plurality of steps to be monitored in said process flow;
storing information regarding said plurality of steps in a database, wherein a subset of said plurality of steps are performed on one or more computer systems in response to first user input, wherein each of said steps comprises one or more process steps;
receiving second user input requesting at least one output;
constructing said at least one output in response to said second user input, wherein said constructing comprises retrieving information from said database.

26. The carrier medium of claim 25, wherein said constructing further comprises processing said retrieved information from said database.

27. The carrier medium of claim 25,
wherein said at least one output comprises a flow file.

28. The carrier medium of claim 25,
wherein said at least one output comprises a comparison of a historical flow file to a reference flow file;
wherein said constructing further comprises creating a report listing differences between said historical flow file and said reference flow file.

29. The carrier medium of claim 25,
wherein said at least one output comprises a report of history of an object in said database;
wherein said constructing further comprises creating said report of history of said object in said database.

30. The carrier medium of claim 25,
wherein said at least one output comprises verification of “up-to-date”-ness of an object in said database;
wherein said constructing further comprises creating an indicator of said “up-to-date”-ness of said object in said database.

31. The carrier medium of claim 30, wherein said object in said database comprises an input.

32. The carrier medium of claim 30, wherein said object in said database comprises an output.

33. The carrier medium of claim 30, wherein said object in said database comprises a step.

34. The carrier medium of claim 25,
wherein said at least one output comprises verification of an outcome of a process that created an output;
wherein said constructing further comprises creating an indicator of said outcome of said process that created said output.

35. The carrier medium of claim 34, wherein said outcome comprises success.

36. The carrier medium of claim 34, wherein said outcome comprises failure.

37. The carrier medium of claim 25,
wherein said at least one output comprises a report of quality of an object in said database;
wherein said constructing further comprises creating said report of quality of said object in said database.

38. The carrier medium of claim 37, wherein said quality is based on a plurality of user-defined metrics.

39. The carrier medium of claim 38, wherein said plurality of user-defined metrics comprise inherited user-defined metrics from an ancestor of said object in said database.

40. The carrier medium of claim 37, wherein said object in said database comprises an input.

41. The carrier medium of claim 37, wherein said object in said database comprises an output.

42. The carrier medium of claim 37, wherein said object in said database comprises a step.

43. The carrier medium of claim 25, further comprising error checking prior to said storing information regarding said plurality of steps in the database.

44. The carrier medium of claim 43, wherein the program instructions are further computer-executable to implement:
fixing any errors found prior to allowing processing to continue.

45. The carrier medium of claim 25, wherein the program instructions are further computer-executable to implement:
error checking subsequent to said storing information regarding said plurality of steps in the database.

46. The carrier medium of claim 45, wherein the program instructions are further computer-executable to implement:
fixing any errors found prior to allowing processing to continue.

47. The carrier medium of claim 25, wherein the program instructions are further computer-executable to implement:
error checking in parallel with said storing information regarding said plurality of steps in the database.

48. The carrier medium of claim 47, wherein the program instructions are further computer-executable to implement:
fixing any errors found prior to allowing processing to continue.

49. A system for capturing and managing a process flow, wherein said process flow comprises a plurality of steps, the system comprising:
A CPU;
a database;
a memory coupled to said CPU, wherein the memory stores program instructions which are executable by the CPU to:
install a monitoring software program for capturing data regarding said process flow;
configure said monitoring software program with configuration information regarding said process flow desired to be monitored, wherein said configuration information comprises information regarding said plurality of steps to be monitored in said process flow;
store information regarding said plurality of steps in the database, wherein a subset of said plurality of steps are performed on one or more computer systems in response to first user input, wherein each of said steps comprises one or more process steps;
receive second user input requesting at least one output;
construct said at least one output in response to said second user input, wherein said constructing comprises retrieving information from said database.

50. The system of claim 49, wherein in said constructing, the program instructions are further executable by the CPU to: process said retrieved information from said database.

51. The system of claim 49,
wherein said at least one output comprises a flow file.

52. The system of claim 49,
wherein said at least one output comprises a comparison of a historical flow file to a reference flow file;
wherein in said constructing, the program instructions are further executable by the CPU to create a report listing differences between said historical flow file and said reference flow file.

53. The system of claim 49,
wherein said at least one output comprises a report of history of an object in said database;
wherein in said constructing, the program instructions are further executable by the CPU to create said report of history of said object in said database.

54. The system of claim 49,
wherein said at least one output comprises verification of “up-to-date”-ness of an object in said database;
wherein in said constructing, the program instructions are further executable by the CPU to create an indicator of said “up-to-date”-ness of said object in said database.

55. The system of claim 54, wherein said object in said database comprises an input.

56. The system of claim 54, wherein said object in said database comprises an output.

57. The system of claim 54, wherein said object in said database comprises a step.

58. The system of claim 49,
wherein said at least one output comprises verification of an outcome of a process that created an output;
wherein in said constructing, the program instructions are further executable by the CPU to create an indicator of said outcome of said process that created said output.

59. The system of claim 58, wherein said outcome comprises success.

60. The system of claim 58, wherein said outcome comprises failure.

61. The system of claim 49,
wherein said at least one output comprises a report of quality of an object in said database;
wherein in said constructing, the program instructions are further executable by the CPU to create said report of quality of said object in said database.

62. The system of claim 61, wherein said quality is based on a plurality of user-defined metrics.

63. The system of claim 62, wherein said plurality of user-defined metrics comprise inherited user-defined metrics from an ancestor of said object in said database.

64. The system of claim 61, wherein said object in said database comprises an input.

65. The system of claim 61, wherein said object in said database comprises an output.

66. The system of claim 61, wherein said object in said database comprises a step.

67. The system of claim 49, wherein the program instructions are further executable by the CPU to perform error checking prior to said storing information regarding said plurality of steps in the database.

68. The system of claim 67, wherein the program instructions are further executable by the CPU to fix any errors found prior to allowing processing to continue.

69. The system of claim 49, wherein the program instructions are further executable by the CPU to perform error checking subsequent to said storing information regarding said plurality of steps in the database.

70. The system of claim 69, wherein the program instructions are further executable by the CPU to fix any errors found prior to allowing processing to continue.

71. The system of claim 49, wherein the program instructions are further executable by the CPU to perform error checking in parallel with said storing information regarding said plurality of steps in the database.

72. The system of claim 71, wherein the program instructions are further executable by the CPU to fix any errors found prior to allowing processing to continue.
